(19) United States
(12) Patent Application Publication
(10) Pub. No.: US 2020/0334667 A1
(43) Pub. Date: Oct. 22, 2020

(54) NOVEL MEANS AND METHODS FOR IMPLEMENTATION OF SECURE TRANSACTIONS

(71) Applicant: Newglobes Ltd., Kefar Yona (IL)

(72) Inventor: Asaf NAIM, Kfar Yona (IL)

(73) Assignee: Newglobes Ltd., Kefar Yona (IL)

(21) Appl. No.: 16/871,836

(22) Filed: May 11, 2020

Related U.S. Application Data
(63) Continuation of application No. PCT/IL2018/051216, filed on Nov. 12, 2018.
(60) Provisional application No. 62/584,967, filed on Nov. 13, 2017.

(51) Int. Cl. G06Q 20/36; G06Q 10/10; G06Q 40/02; G06Q 30/00; G06Q 20/10; G06Q 20/34; G06Q 20/06; G06F 16/23

(52) U.S. Cl. CPC G06Q 20/3674; G06Q 10/10; G06Q 40/025; G06Q 30/0185; G06Q 2220/00; G06Q 20/34; G06Q 20/0655; G06F 16/2372; G06Q 20/108

(57) ABSTRACT

A capital management system enabling sanctioned secure flow of capital from blockchain environment to creditor entities comprising a. a client's capital blockchain secured smart contract including a client sanctioned withdrawal of capital module configured to release capital upon request of said client b. an electronic creditor entity activated client smart wallet, said smart wallet including an interrogation module said client's capital blockchain secured smart contract (contract A), interconnected with said client smart wallet interrogation module and said electronic creditor entity wherein said smart wallet interrogation module is configured to interrogate said client's capital blockchain secured smart contract and verify status of said smart contract A of predetermined terms and requirements of said credit entity and upon verification activate said sanctioned withdrawal of capital and transfer payment from said client's capital blockchain secured smart contract to said smart wallet, said smart wallet configured to automatically transfer funds to said creditor entity.

### CROSS-REFERENCE TO RELATED APPLICATIONS

This application is a continuation of International Application No. PCT/IL2018/051216 filed on Nov. 12, 2018, which claims priority from U.S. Provisional No. 62/584,967, filed Nov. 13, 2017, the contents of which are hereby incorporated by reference.

### TECHNICAL FIELD

The present disclosure pertains to the processing of data and verifications in electronic payment systems. The present disclosure pertains to the use of blockchain technology in online financial transactions. More particularly, the present disclosure is concerned with facilitating the efficient and safe use of credit cards by harnessing blockchain technology.

### BACKGROUND

There are several obstacles to free and widespread use of smart contract and blockchain technology in the credit & debit card industry. Some of these obstacles are:
1. The demands of credit card companies to have existing client capital under their control at the time of the credit card payment.
2. Blockchain transaction fees are high, rendering the use of blockchain technology uneconomical for small transactions, whereas most credit card transactions fall within the category of small purchases.
3. Blockchain systems may be overwhelmed by the huge number of transactions per hour, a demand typical to functioning credit card systems.
4. Credit card payments require seconds for approval of transactions after a “swipe,” but blockchain technology requires a minimum of thirty seconds to several hours for approval.
5. Current credit card usage requires the client to transfer the cryptocurrency directly under the control of the credit card company, and out of the protection of the blockchain. Today, credit card companies today have to secure this cryptocurrency.

All of the above factors may provide some explanation of the lack of widespread use of blockchain technology within the credit card and debit card industry. Thus, a long-felt and unmet need exists to provide appropriate technical solutions to overcome the above obstacles.

### SUMMARY

It is an object of the present disclosure to provide a capital management system enabling sanctioned secure flow of capital from a blockchain environment to electronic creditor entities, comprising: a client's capital blockchain-secured smart contract, including a client-sanctioned withdrawal of capital module configured to release capital upon request of the client; an electronic creditor-entity-activated client smart wallet, the smart wallet including an interrogation module, wherein the client's capital blockchain-secured smart contract (contract A) is interconnected with the client smart wallet interrogation module and the electronic creditor entity, and wherein the smart wallet interrogation module is configured to interrogate the client's capital blockchain-secured smart contract and verify the status of the smart contract (A) and of predetermined terms and requirements of the credit entity and, upon verification, to activate the sanctioned withdrawal of capital module and transfer payment from the client's capital blockchain-secured smart contract to the smart wallet, the smart wallet being configured to automatically transfer funds to the creditor entity.

It is another object of the present disclosure to provide the aforementioned system, wherein the creditor entity is a credit card system or any online or partially-online payment system.

It is another object of the present disclosure to provide a capital management system enabling sanctioned secure flow of capital from individual clients' capital blockchain-secured smart contracts, within a pool of client capital blockchain-secured smart contracts (C), to electronic creditor entities payment systems, wherein the capital management system comprises: a pool of bundled smart contracts (C) comprising a plurality of individual clients' capital blockchain-secured smart contracts; and a smart wallet (F) comprising a plurality of individual clients' smart wallets, wherein the pool (C) is interconnected with the client smart wallet (F) interrogation module and the electronic creditor entity, wherein each smart wallet includes a smart wallet interrogation module configured to interrogate the status of the individual client's smart contract within the pool (C) and to report the status of the individual smart contract to an external payment system of the creditor entity; and wherein each of the individual client's capital blockchain-secured smart contracts includes a corresponding sanctioned withdrawal of capital module, configured to enable repatriation of capital to an owner at a predetermined time, within predetermined periods and periodicity, and transfer of capital to the smart wallet on fulfillment of smart contract conditions and specifications, the smart wallet (F) being configured to automatically transfer funds at least equal to a plurality of funds held in the individual's smart wallets within (F) and received, from the pool (C), by the creditor entity.

It is another object of the present disclosure to provide the aforementioned system, wherein the creditor entity is a credit card system or at least any partially-online payment system.

It is another object of the present disclosure to provide a method for enabling sanctioned secure flow of capital from a blockchain environment to electronic creditor entities, comprising steps of: sanctioning withdrawal of capital from a smart contract configured to release capital upon request of the client; and activating a client smart wallet and interrogating the client's capital blockchain-secured smart contract (contract A), wherein interrogating the client's capital blockchain-secured smart contract (contract A) includes verifying fulfillment by the smart contract (A) of predetermined terms and requirements of the credit entity, whereupon the smart wallet transfers payment from the client's capital blockchain secured smart contract to the smart wallet, and the smart wallet then automatically transfers funds to the creditor entity.

In an embodiment of the aforementioned method wherein the creditor entity is a credit card system or at least any partially-online payment system.

It is an object of the present disclosure to disclose the aforementioned method enabling sanctioned secure flow of capital from individual clients' capital blockchain-secured smart contracts, within a pool of client capital blockchain-secured smart contracts (C), to electronic creditor entities payment systems, wherein the method comprises the steps of: bundling a pool of smart contracts (C), comprising a plurality of individual clients' capital blockchain secured smart contracts, and providing a bundled smart wallet (F), comprising a plurality of individual clients' smart wallets; interconnecting the pool (C) with the client smart wallet (F) interrogation module and the electronic creditor entity, wherein each smart wallet interrogation module interrogates the status of the individual client smart contracts within the pool (C), and reporting the status of the individual smart contract to an external payment system of the creditor entity; and sanctioning repatriation of capital from the individual client smart contract at a predetermined time, within predetermined periods and periodicity, and transferring capital to the smart wallet upon fulfillment of smart contract conditions and specifications, the smart wallet (F) being configured to automatically transfer funds at least equal to a plurality of funds, held in the individual's smart wallets within (F) and received from the pool (C), to the creditor entity at a predetermined time, within predetermined periods and periodicity.

It is another object of the present disclosure to disclose the aforementioned method, wherein the creditor entity is a credit card system or any online payment system.

### BRIEF DESCRIPTION OF THE FIGURES

In order to understand the disclosure and to see how it may be implemented in practice, a plurality of embodiments are adapted to now be described, by way of non-limiting example only, with reference to the accompanying drawings:

FIG. 1 schematically illustrates a first aspect of the modules and methods of the present disclosure.

FIG. 2 schematically illustrates a second aspect of the modules and methods of the present disclosure.

The following description is provided, alongside all chapters of the present disclosure, so as to enable any person skilled in the art to make use of the disclosure, and sets forth the best modes contemplated by the inventor of carrying out this disclosure. Various modifications, however, are adapted to remain apparent to those skilled in the art, since the generic principles of the present disclosure have been defined specifically to provide novel methods for Implementation of Secure Transactions.

### DETAILED DESCRIPTION OF THE FIGURES

Definitions of some terms are described herein:

It is herein acknowledged that the term “smart contract” refers to a computer protocol, or manifestations thereof, intended to facilitate, verify, or enforce the negotiation or performance of a contract.

Smart contracts facilitate the automatic self-execution or self-enforcement of contractual clauses. Smart contracts provide security superior to traditional contract law and reduce transaction costs associated with contracting.

It is herein acknowledged that the term “specification” refers to any predetermined property of a contract, non-limiting examples include total sums, time request limits, or delay limits.

It is herein acknowledged that the term “Blockchain” or “Block Chain” refers to a continuously growing list of records called blocks, cryptographically linked and secured. Each block typically contains a hash pointer as a link to a previous block, a timestamp, and transaction data. By design, blockchains are inherently resistant to modification of the data. A blockchain can serve as an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

Blockchains are secure by design and are an example of a distributed computing system with high Byzantine Fault Tolerance. Decentralized consensus has, therefore, been achieved with a blockchain. This makes blockchains potentially suitable for the recording of events, medical records, and other records management activities, such as identity management, processing of transactions, documenting provenance, or traceability of food and other goods.

The disclosed embodiments pertain to the processing of data and verifications in electronic payment systems, in order to mitigate risk and reduce processing load.

The disclosed embodiments herein pertain to blockchain networks.

The disclosed embodiments herein pertain to permission and access control systems.

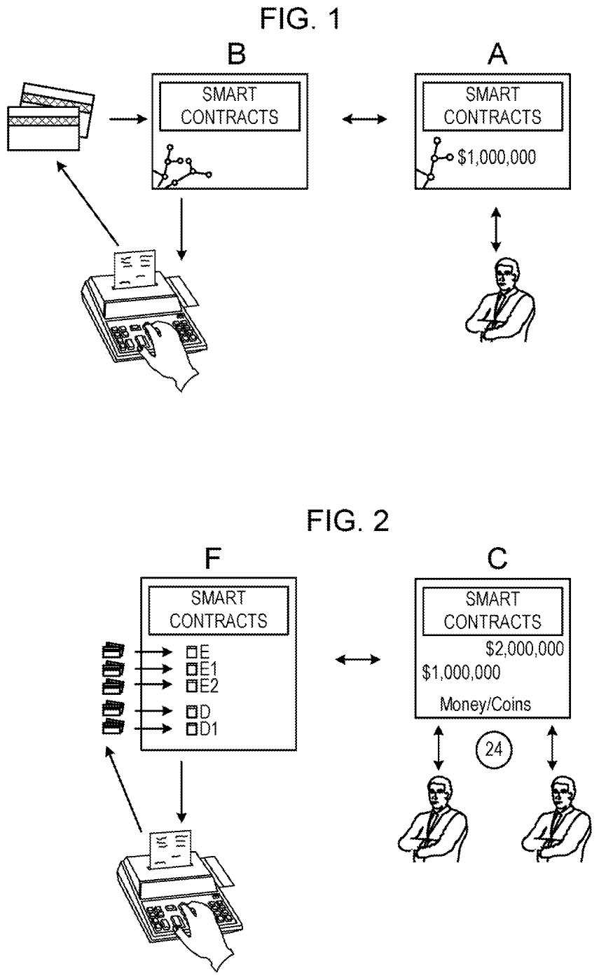

FIG. 1. The present disclosure provides means and methods for the management of capital through a “smart contract” (Contract A) on blockchain technology, whilst enabling the client's “smart wallet” (a “smart” contract in itself, Contract B) to request Contract A for capital.

The creator of the initial contract, contract A, has two-way accessibility to the account. The creator can both deposit to, and retrieve capital from, and from the account.

The credit card makes requests of contract B (one-way), yet contract B never has capital permanently stored in it. When contract B is charged by the credit card, it requests capital from the initial contract, contract A (requester/giver relationship).

Contract A identifies the requesting contract B, and if contract A successfully identifies contract B, it begins assessing the pre-defined limitations and whether the specific request matches the limitations.

The moment contract B receives capital, the credit firm authorizes the card transaction (transferring capital to the business).

The capital received by contract B can only be paid to the credit card firm, as explained in the previous clause.

Contract B is linked to the client's credit/debit card. Contract B is empty at the starting point and initially does not hold any capital.

When the associated credit card is used (for example, swiped) and a charge is incurred, a signal is transmitted to contract B. Contract B is then activated to request contract A for capital.

The module of contract A then initiates steps comprising:
1. verifying the identity of contract B;
2. if the identity of contract B is not verified, transfer of funds from contract A is refused and blocked;
3. if the identity of contract B is verified, predefined specifications of contract B are verified;
4. if predefined specifications of contract B are not verified, transfer of funds from contract A is refused and blocked;
5. if contract B's specifications match the pre-defined specification requisites defined by the creator of contract A, the desired sum is transferred on the blockchain technology;
6. the credit card firm module is alerted that contract B is in possession of funds;
7. the credit card module approves the transaction; and
8. moves the capital to the cc firm's wallet from contract B.

It is within the scope of the present disclosure that, at any given moment, the creator of contract A may retrieve capital from contract A of the account, and is the only party able to retrieve from the account besides the aforementioned process of withdrawal by contract B. This way, the initial creator of contract A never relinquishes control of their capital, yet the credit card companies' demands for payment security are met. The disparity between the credit card company's rapid approval and blockchain approval time delays is also satisfied, since smart contract B rapidly verifies the status of smart contract A and reports it to the credit card company automatic module very quickly, and, therefore, there are no money transfer approval delays. The credit card company payment receiving module is assured of the customer's smart contract A's status, and is assured that smart contract B will transfer the funds according to the pre-agreed terms.

FIG. 2

It is, however, acknowledged that blockchain transaction fees are high, rendering the use of blockchain technology uneconomical for small transactions, whereas most credit card transactions fall within the category of small purchases. It is, moreover, important to reduce the possibilities of overload on any payment system, so another embodiment of the present disclosure is disclosed herein in FIG. 2.

Each creator creates their own initial “smart” contract, and several individual creators' smart contracts (often with different specifications) are merged into a central “smart” contract (Contract C, POOL). There is a 24-hour (for example) time frame for the withdrawal of cash. Each creator can both deposit and retrieve their cash.

The credit cards are linked to the “smart” contracts, which are currently centralized under one ‘POOL’ contract, wherein only the ‘POOL’ contract can pay the credit card firms (Contract F). When the card is used, the “smart” contract that is linked to the credit card awaits the approval of contract C, which assesses the request's specifications. If the specifications match the predefined conditions, then the request is authorized by the credit card company. Note that this transaction does not work through blockchain, but “credit” that is based on a constant status check of the initial contract's capital. The total sum of the day/month's transactions, through blockchain technology, is passed to the credit firm (according to requests/circumstances limitations). In this manner, the blockchain technology's “processing fee” and processing action is incurred only once, and not multiple times for every small transaction, and there is little congestion on the blockchain network.

### Implementation Example

John creates his “smart” contract and deposits a million USD. Robert does the same, depositing into his account two million USD. This set of contracts is bundled and merged into one central “smart” contract (POOL, Contract C). At the creation of each initial contract, each client designates the conditions and number of wallets he would like to have (no limits on number of wallets). For example, John created two “smart” contracts (D|D1) and Robert created three “smart contracts” (E|E1|E2). Subsequently, another contract is set up that is linked with the credit firm (for withdrawal, contract F). This contract, in essence, connects the client's wallet to his withdrawal contract that allows him to use his credit card to withdraw cash. Thereby, contract F cannot request capital from contract C, unless it was requested by one of the wallets.

For example's sake, consider the following circumstances:
John's conditions
   Contract D can request of contract C (through contract F) up to $100,000 USD in total, and not in excess of $5000 monthly and $100 daily.
   Contract D1 can request of contract C (through contract F) up to $900,000 USD in total, and not in excess of $20,000 monthly and $500 daily.
Robert's conditions
   Contract E can request of contract C (through contract F) up to $100,000 USD in total and not in excess of $5000 monthly and $100 daily.
   Contract E1 can request of contract C (through contract F) up to $900,000 USD in total and not in excess of $20,000 monthly and $500 daily.
   Contract E2 can request of contract C (through contract F) up to $1,000,000 USD in total and not in excess of $50,000 monthly and $1,500 daily.

Contract C, with the following conditions, is accessible and transparent to all parties on the blockchain (no transaction required). Yet, simultaneously, the creator of the initial contract can, at any given moment, nullify the wallets and retrieve all remaining capital. With that exists the problem that, if the initial contract creator can, at any given moment, retrieve his capital, it hinders the process of a status check due to the necessity for blockchain validation.

For this precise reason, there is an added component of a prescribed time frame (e.g 24 hours) for the time between requests to retrieve capital from contract C back to the creator.

This ensures the integrity of the payment system as, on one hand we would like to expedite the transaction as swiftly as possible to allow for convenient spending but, on the other, prevent potential fraud, as the creator of the initial contract can retrieve his capital whilst the wallet holders are still in debt (by virtue of holding ‘credit’ accounts).

Furthermore, when a credit card is used (e.g credit card, contract E), contract E requests contract C (through contract F) for a status check. If all the account limitations and transfer specifications match, the status check is completed and the credit firm authorizes the transaction.

Thus, the role of credit firms in this over-arching process is different in the following four ways:
1.The firm does not want to take capital from contract C because it is not interested in paying the “blockchain processing fee.”
2. The credit firm or entity is not required to approve the transaction of cryptocurrency/capital because it is a status check and not an actual transaction that requires blockchain approval.
3. Once in a given period (e.g once a day), contract F requests of contract C capital equal to the total sum of transactions executed today (by all wallets collectively), thus taking full advantage of the nature of “blockchain processing technology” (fixed fee invariable of transferred amount).
4. The blockchain processing activity is reduced because bulk aggregated funds from the pool smart contract C are transferred to smart wallet F at predetermined periodicities.

In the case that the creator of contract C asks to retrieve some or all of his capital, this request is conveyed to the blockchain network. If this happens, contract F immediately asks contract C for incurred charges on the card (as opposed to the 24 hours given as “credit”).

### Further Examples and Applications

There are thousands of potential applications for the integration of the previously mentioned technologies, even without the use credit cards.

Another use case example:

A customer can transfer and create a smart contract that will combine a number of transactions, such as payments to a company (Company X) of $20 per month ($240 per year) plus payment to the electricity company of $63.33 per month ($760 per year) (as stated, he can withdraw them at any given moment), while Company X and the Electricity Company will be able to access the contract once a month and actually withdraw their share according to the agreement with the customer.

Another example: A software engineering firm named X licenses client Tom their program for a monthly payment (e.g., $20 USD). When Tom pays $20 USD monthly, he will also be charged the blockchain processing fee (e.g., $3 USD, 20%). For that reason, firm X can allow its clients to use the previously explained method.

In this case, the client will deposit a yearly sum ($240 USD) into a “smart” contract. The creator can, once again, retrieve his capital at any time, given the twenty-four hour time frame, while. Simultaneously. Firm X withdraws the payments of its customers once a month. So, if the firm has one hundred clients, the firm will withdraw once 100*$20 ($2000 USD), hence incurring the small invariable blockchain processing fee (there is another negligible fee for internal management within the centralized contract).

Paying the blockchain processing fee, when he transfers the capital to the “smart” contract, he will pay an additional (100/12)/fee.

Enumerated, if the fee was $3 USD, the client would pay $3 USD in transferring capital to the “smart” contract, and (12/100)/3, or $0.36 USD.

In all of its embodiments, the present disclosure pertains to the processing of data and verifications in electronic payment systems, in order to mitigate risk and reduce processing load.

What is claimed is:

1. A capital management system enabling sanctioned secure flow of capital from a blockchain environment to electronic creditor entities, comprising:
a client's capital blockchain-secured smart contract including a client-sanctioned withdrawal of capital module configured to release capital upon request of the client; and
an electronic-creditor-entity-activated client smart wallet, the smart wallet including an interrogation module, the client's capital blockchain-secured smart contract (contract A) interconnected with the client smart wallet interrogation module and the electronic creditor entity, wherein the smart wallet interrogation module is configured to interrogate the client's capital blockchain-secured smart contract and verify the status of the smart contract A of predetermined terms and requirements of the credit entity and, upon verification, activate the sanctioned withdrawal of capital module and transfer payment from the client's capital blockchain-secured smart contract to the smart wallet, the smart wallet configured to automatically transfer funds to the creditor entity.

1. The system according to claim 1, wherein the creditor entity is a credit card system or any online or partially-online payment system.

2. A capital management system enabling sanctioned secure flow of capital from individual clients' capital blockchain-secured smart contracts, within a pool of client capital blockchain-secured smart contracts C, to electronic creditor entities payment systems, wherein the capital management system comprises:
a pool of bundled smart contracts C, comprising a plurality of individual clients' capital blockchain-secured smart contracts; and
a smart wallet F, comprising a plurality of individual clients' smart wallets, the pool C being interconnected with the client smart wallet F interrogation module and the electronic creditor entity, wherein each smart wallet includes a smart wallet interrogation module configured to interrogate the status of the individual client smart contract within the pool C and to report the status of the individual smart contract to external payment system of the creditor entity, and wherein each of the individual client's capital blockchain-secured smart contracts includes a corresponding sanctioned withdrawal of capital module configured to enable repatriation of capital to an owner at a predetermined time, within predetermined periods and periodicity, and to transfer capital to the smart wallet on fulfillment of smart contract conditions and specifications, the smart wallet F being configured to automatically transfer funds at least equal to a plurality of funds held in the individual's smart wallets within F, and received from the pool C, to the creditor entity.

3. The system according to claim 3, wherein the creditor entity is a credit card system or any at least partially-online payment system.

4. A method for enabling sanctioned secure flow of capital from a blockchain environment to electronic creditor entities, comprising steps of:
sanctioning withdrawal of capital from a smart contract configured to release capital upon request of the client; and
activating a client smart wallet and interrogating the client's capital blockchain secured smart contract (contract A), wherein interrogating the client's capital blockchain secured smart contract (contract A) includes verifying fulfillment, by the smart contract A, of predetermined terms and requirements of the credit entity, whereupon the smart wallet transfers payment from the client's capital blockchain-secured smart contract to the smart wallet, the smart wallet then automatically transferring funds to the creditor entity.

5. The system according to claim 5, wherein the creditor entity is a credit card system or any at least partially-online payment system.

6. The system according to claim 1, wherein the creditor entity is a credit card system or any online payment system.

7. A method enabling sanctioned secure flow of capital from individual clients' capital blockchain-secured smart contracts, within a pool of client capital blockchain-secured smart contracts C, to electronic creditor entities payment systems, wherein the method comprises:
bundling a pool of smart contracts C comprising a plurality of individual clients' capital blockchain-secured smart contracts;
providing a bundled smart wallet F comprising a plurality of individual clients' smart wallets;
interconnecting the pool C with the client smart wallet F interrogation module and the electronic creditor entity, wherein each smart wallet interrogation module is interrogating the status of the individual client smart contract within the pool C, and reporting the status of the individual smart contract to an external payment system of the creditor entity; and
sanctioning repatriation of capital from the individual client smart contract at a predetermined time, within predetermined periods and periodicity, and transferring capital to the smart wallet upon fulfillment of smart contract conditions and specifications, the smart wallet F being configured to automatically transfer funds at least equal to a plurality of funds, held in the individual's smart wallets within F and received from the pool C, to the creditor entity at a predetermined time, within predetermined periods and periodicity.
